(19) United States
(12) Patent Application Publication
(10) Pub. No.: US 2016/0104215 A1
(43) Pub. Date: Apr. 14, 2016

(54) Customer Live Communication Marketing and Integrated CRM Tool

(71) Applicants: William Cist, New York, NY (US); Guang Yang, New York, NY (US)

(72) Inventors: William Cist, New York, NY (US); Guang Yang, New York, NY (US)

(21) Appl. No.: 14/731,248

(22) Filed: Jun. 4, 2015

Related U.S. Application Data
(60) Provisional application No. 62/007,879, filed on Jun. 4, 2014.

(51) Int. Cl. G06Q 30/02; H04W 4/12; G06Q 30/06

(52) U.S. Cl. CPC G06Q 30/0281; G06Q 30/0641; H04W 4/12

(57) ABSTRACT

An all-in-one business management solution application and system is described which details elements pertaining to the implementation and integration of a CRM, analytics, scheduling, and reporting tool. The application is configured to connect a business to a customer or client via an integrated live chat option existent within the business' native smartphone application to further facilitate direct communication between the business and the customer outside of a traditional telemarketing, email blast, text based, or direct mail marketing campaigns. Customers or prospects are linked, via their member ID, to their mobile store application on their mobile devices, facilitating communication to the customer throughout the shopping experience by a customer service representative or similar support personnel

### CONTINUITY

This application is a non-provisional application of provisional application No. 62/007,879, filed on Jun. 4, 2014, and priority is claimed thereto.

### FIELD OF THE PRESENT INVENTION

The present invention relates to online resource and customer management tools, and more specifically, relating to tools that organize and communicate to the customer base of a company, as well as those that provide on-the-go access to these tools, equipped with the capacity to perform on-the-fly changes to execute a variety of marketing campaigns.

### BACKGROUND OF THE PRESENT INVENTION

Oftentimes, in the realm of modern marketing practices, the goal is to achieve ever-more personal campaigns that execute precise targeting to an ideal selection set of customers, and provide a personal touch to establish a dialogue with a customer easier. The advancement of the Internet and computers have drastically facilitated the tracking of customers' habits and purchases, and have even come to anticipate the needs of the customer before they happen. While e-mail blast campaigns have largely taken over for much of the Direct Mail marketing efforts, some argue that an e-mail is simply not personal enough. E-mails may include the customer's name, as well as other information pertaining to promotional codes, and previous purchase history—all information retrieved directly from the company's customer database, which is conventionally routed through a CRM (Customer Relationship Management) tool consistent and compliant with SQL, SQLite, or similar database programming languages.

Unfortunately, most of these tools are decidedly non-operable on a mobile device, with the exception of campaign alerts or initiating a campaign from a mobile device.

While it is known that these efforts have provided great strides in facilitating rapid communication with a customer, and frequently successfully marketing to this customer, it rarely results in direct audible or face-to-face communication except when telemarketing is employed as a marketing channel. If there were means of facilitating a direct communication channel between a customer and a business via a live chat channel within the conventional store application for a company, companies would be better able to cater personally to their customer base.

Likewise, it is now a common practice for companies wishing to professionally market to their customer base to have an independent mobile ‘app’ or application which provides a more direct link to the customer than a simple website would provide. A store ‘app’ on the Apple Store or Google Play Store can provide additional tracking data, and provide a direct avenue for customers to purchase goods or services from the company via the company's independent ‘app.’

Unfortunately, there conventionally exists a disconnect between the company's ‘app’ on mobile devices and to CRM tools designed to facilitate the marketing campaigns efficacy to customers across a wide variety of channels.

Thus, there is a need for a mobile CRM tool capable of direct integration with a company's unique mobile application conventionally found on iOS, Android, or other similar smartphone operating system and architecture. Such a tool would preferably facilitate direct, live-chat communication between the customer and a representative of the company, providing an evermore personal touch to marketing efforts.

### SUMMARY OF THE PRESENT INVENTION

The present invention is a Customer Relationship Management (CRM) tool and customer communication channel that provides a more direct dialogue between a company and its customer base. The preferred embodiment of the present invention employs conventional CRM tool applications embodied into a mobile framework that provides users the capacity to establish inter-application communication between a customer and a company.

Via the present invention, conventional CRM solutions are integrated within a mobile application, and are connected to and sourced from the company's public ‘app’ from the Apple iOS store, Google Play store, or other similar Smartphone architecture. The architecture behind the applications of the present invention is configured to provide companies with all-in-one business management platform. The all-in-one application of the present invention provides Live Chat, email blast marketing campaign execution and creation, reservation placement handling, scheduling, direct mail marketing campaign creation and execution, reporting and analysis—including but not limited to marketing analysis, financial analysis, employee evaluation, sales analysis, and reservation analyses.

### BRIEF DESCRIPTION OF THE DRAWINGS

FIG. 1 displays a relational diagram of the elements of the application of the present invention.

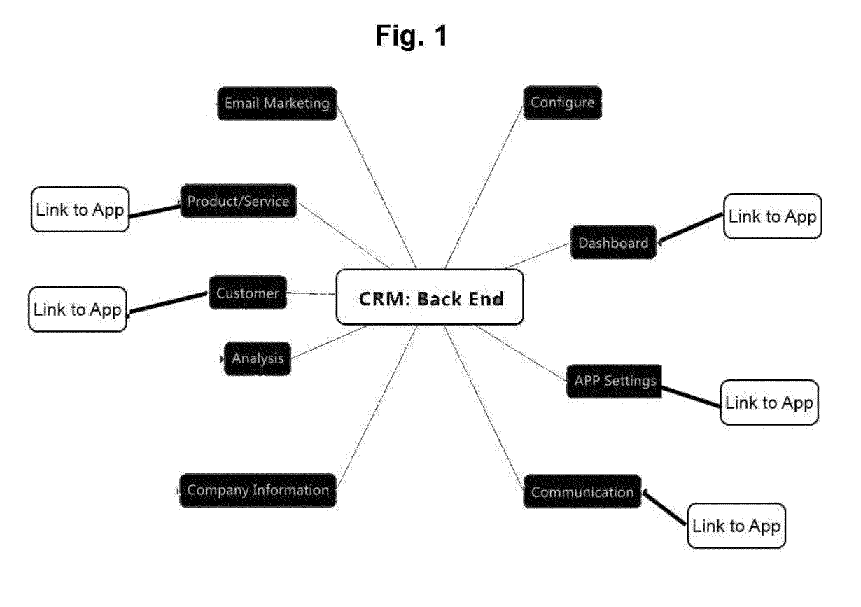

FIG. 2 displays an information web depicting the primary tools of the present invention.

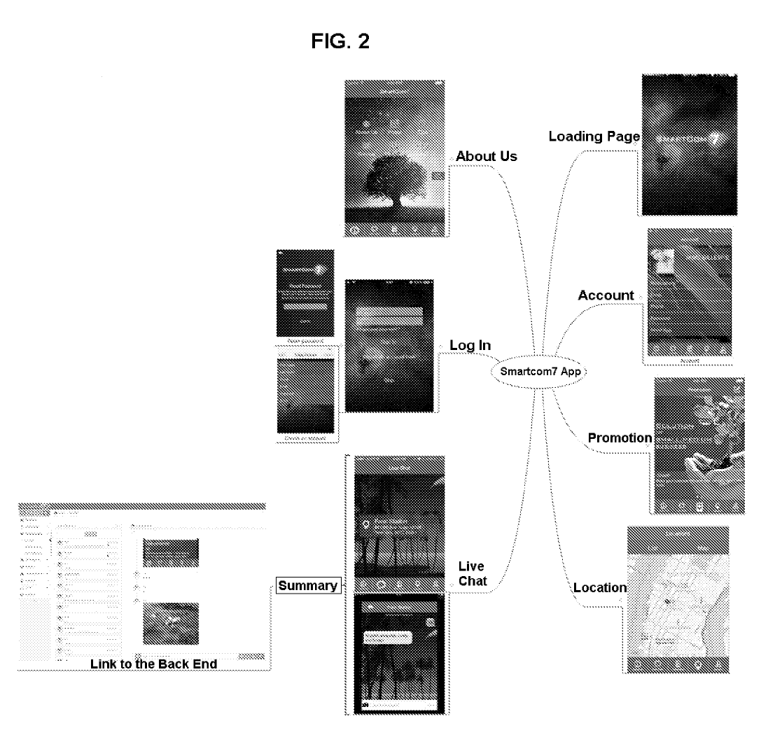

### DETAILED DESCRIPTION OF THE PREFERRED EMBODIMENT

The present invention is an all-in-one solution tool for businesses or companies that is configured to ease the marketing and communication process between a company and its client base. The present invention provides a complete Customer Relationship Management (CRM) tool, a full reporting analytics suite, in addition to back-end live chat integration across multiple applications. The integration of a live chat feature into the CRM tool on the business end, and into the mobile store mobile application or online marketplace application on the customer end.

The components of the application of the present invention include a back end and a customer end, which are detailed as follows:

### Customer End (via the Company Store Application):

1. Page Layout

Page layout organization: live chat bubble, text, image, time and basic function buttons display and organization.

2. Network Transfer

Transfer network data, including sending and receiving data and connecting to the server.
3. Data transfer A data transfer agreement is enacted between the app and the server, including handshaking protocol,text data protocols, image data protocol, and coding and decoding data.

4. Data Encryption and Decryption

Configured for protection and safety of the data.

5. A data cache is employed within the application of the present invention, and is designed for saving and loading data to the mobile device.

6. Troubleshoot bugs for internet port connections pertaining to receiving and sending data over the network.

### Back End of the Client Application (via the CRM Application on the Business Side)

1. Page Layout and Display

Responsible for the display and layout of the customer side of the chat window.

2. Customer Service Groups Management

Ensure that customers can communicate with a specific business

3. Network Transfer

Network data transmission, sending and receiving data and connecting to customer end

4. Data Transfer

App and server data transmission protocols, including handshake protocols, text data protocols and image data protocols, and data encryption and decryption.

5. Data Encryption and Decryption

Encrypt and decrypt data to protect data

6. Data Storage for a Long Period

Store sent and received data to the database permanently on server until request for deletion is received.

7. Troubleshoot Bugs

Troubleshoot network bugs when receiving and sending data, and running the program.

8. Customer Management

Manage customer information and allocate to correct fields within relational database.

### The Logic Behind Live Chat is as Follows:

Live chat is configured to allow users to communicate instantly between mobile terminals and the server through the Internet.

From mobile apps:

1. Send handshake data in order to build a connection with server

2. Send text messages or images

3. Store sending message in server

4. Listen and receive the messages from the server

5. Store receiving message in server

6. Tag all incoming and outgoing messages with a unique member ID and time

7. Retrieve and load previous conversation based on the member ID and time in a chronological order.

From the server:

1. Search customers from the server and send messages

2. If the app is logged in, the message will be sent directly to the app

3. If the app is not logged in, the message will be sent to the apple message center. The message center will then send the message as a notification. (Under ios system)

### Live Chat Components

APP Side—Design from Within Marketplace Application or Online Store;

1. Page Layout Module

Completion of the layout and presentation of the bubbles, text, pictures, time, and the basic function buttons.

2. Network Transmission Module

The network transmission module is responsible for transmission of network data, sending messages, receiving messages, and maintaining the server connection.

3. Data Transmission Protocol

Data transmission protocols between App and server, including handshaking protocols, text data and picture data protocols, and data encoding and decoding process.

4. Data Encryption and Decryption

The transmitted data employs conventional data encryption and decryption processing, and data security for all communications executed over the system of the present invention.

5. Data Cache Module

The cache data to the phone

6. Exception Handling Module

For network anomalies, abnormal receiving data, sending data anomalies

### Back End CRM

1. Page Layout and Display

Responsible for the layout and presentation of the service side of the chat window, preferably from within the CRM tool portion of the system of the present invention.

2. Customer Groups (Locations) Management

To ensure that customers can communicate with designated locations

3. Network Transmission Module

Responsible for network data transmission, send messages, receive messages, the client-end connection.

4. Data Transmission Protocol

Data transmission protocols between App and server, including handshaking protocol, text data and image data protocols, and data encoding and decoding process.

5. Data Encryption and Decryption

The transmitted data encryption and decryption processing, data security

6. Data Persistence Module

To receive and send messages to the database persistently

7. Exception Handling Module

For network anomalies, receiving data anomalies sends data processing and runtime exception.

8. Customer Management

Manage customer information.

### 2. Logic Behind Live Chat

Through the network, users of the application of the present invention may employ an instant messaging feature between mobile terminals and the server. The messaging feature is preferably executed over a secured connection as follows:
Steps to send a message through a Mobile terminal via the client application of the present invention:

1. Send a handshake message to the server to establish a connection

2. Send text or image messages

3. Save message cache

4. Listen and receive a message sent to the server

5. Save received cache messages

The server sends a message:

1. The server finds customers using their member ID and sends a message or image.

2. If App users have logged in, messages will be sent directly to the app.

3. If App users have not logged in, a message is sent to the apple push message center, and the message center will send the message to the push mobile terminal (app mobile terminal as ios).

### Live Chat Flow:

1. A customer connects to the server through the store mobile application.

2. The request connection to the server succeeds, and the store mobile application (marketplace mobile app) is connected to the server.

3. A handshake message is sent to the server.

4. The Server decodes handshake message, identifies the customer, and waits for the server or the app to send messages or images.

5. The app sends text or image messages

6. The app server receives the message; identifies the message types and customers

7. Messages are saved to the database

8. Display messages to the specified customer service

9. Customer service sends a message to the server tagged with a specified member ID.

10. The server uses the member ID to send the message to a specified customer's app.

11. App receives the messages, which are displayed, or notifications for the message's arrival are sent to the customer.

12. Customer service sends images to a specific folder in the server and its respective URL to the data tagged with a specified member ID.

13. The customer's app receives the URL of the image

14. App sends an http request to get the picture and display

15. The customer closes the app, and the link to the server is disconnected

Via the system of the present invention, a user is able to simultaneously have a live chat conversation with a customer, including audio, video, and/or text based communication, as well as maintain a direct connection to the database of information relating to the customer populated via the CRM tool. Therefore, the customer service individual can be active within the CRM function of the present invention while maintaining a direct communication link to the customer browsing the online store or marketplace simultaneously.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

We claim:

1. A method of organizing and utilizing customer data comprising:
Uploading customer data to a database;
Accessing the data via a client application;
Wherein said client application is a mobile application on a mobile device;
Employing the data to communicate with customers in real time as they visit an online store in communication with the client application;

2. A system for communicating from a CRM tool with customers shopping in an online store application comprising:
the online store application connecting to a server via will of a customer on a mobile device;
the server requesting authentication from the online store application;
the server permitting the connection between the store mobile application and the server;
the online store application sending a handshake message to the sever;
the server decoding the handshake message;
the server identifying the customer based on a member ID from a customer database in communication with the server;
the server awaiting communication data from the customer via the store mobile application;
the customer sending messages to the server;
the server receiving the messages;
the server identifying the message type;
the server saving the messages to the customer database;
the server displaying messages to a directed customer service representative operating within the CRM tool;
the customer service representative sending a massage responding to the customer, directed to the customer's member ID via the server;
the store mobile application receives the message;
the store mobile application displaying the message on a screen of the mobile device to the customer;
the customer service representative sending images to a specific folder on the server correlating to the member ID of the customer;
the store mobile application of the customer corresponding to the member ID of the images receives the URL(s) of the images; and
the customer's mobile device displaying the transmitted images.
